(19) United States
(12) Patent Application Publication
(10) Pub. No.: US 2017/0291833 A1
(43) Pub. Date: Oct. 12, 2017

(54) WATER ADJUSTMENT TECHNIQUES FOR CREATION OF DISINFECTANT

(71) Applicants: Michael FLORMAN, Pacific Palisades, CA (US); ECOCLEAN USA INC, Los Angeles, CA (US)

(72) Inventor: Michael FLORMAN, Pacific Palisades, CA (US)

(21) Appl. No.: 15/507,239

(22) PCT Filed: Aug. 31, 2015
(86) PCT No.: PCT/US2015/047783

§ 371 Date: Feb. 27, 2017

Related U.S. Application Data
(60) Provisional application No. 62/043,624, filed on Aug. 29, 2014.

(51) Int. Cl. C02F 1/467; C25B 1/26; A01N 59/00

(52) U.S. Cl. CPC C02F 1/4674; A01N 59/00; C25B 1/26; C02F 2201/46135; C02F 2201/4614; C02F 2201/4615

(57) ABSTRACT

Described is a system for generating a disinfectant using water from a local source. The system comprises water from a local source having a set of characteristics; a set of stable minerals and buffers produced in accordance with the set of characteristics of the water; and an electrical device for delivering electricity to the water to produce a desired disinfectant. By adding the minerals and buffers to the water, a user can control at least one chemical property of the desired disinfectant produced using the water from a local source.

### CROSS-REFERENCE TO RELATED APPLICATIONS

This is a Non-Provisional Application of U.S. Provisional Patent Application No. 62/043,624 filed Aug. 29, 2014, entitled, “Water Adjustment Method When Making Disinfectants,” the entirety of which is incorporated herein by reference.”

### BACKGROUND OF THE INVENTION

### (1) Field of Invention

The present invention relates to a system for water adjustment for disinfectant generation and, more particularly, to a system for water adjustment for disinfectant generation using local water sources.

### (2) Description of Related Art

Disinfectant can be generated through electrolysis by combining water, minerals, buffers, and electricity. When salt (e.g., sodium chloride (NaCl)) is electrolyzed, the chlorine (Cl) off of the NaCl molecule binds to hydrogen and oxygen from water to form HOCl and other chlorine species (e.g., NaOCl, H+, Cl−). HOCL, or free chlorine as it is referred to, is the active form of chlorine that is used as a disinfectant.

The environmental protection agency (EPA) requires that manufacturers who sell machines that generate disinfectants perform stringent microbiological testing to prove that the disinfectant, or sanitizer being produced, kills the desired organisms and can kill organisms repeatedly in the same way each time the product is used. On-site generation of disinfectant, therefore, needs to be able to reproducibly produce the same disinfectant regardless of local water characteristics.

Manufacturers who wish to sell machines to end users to create on-site disinfectant, such as HOCl, using local water sources, need a method to standardize or alter the water properties so the final produced chlorine species generated by the machines always has the same properties and killing efficacy, along with controlling other characteristics of the solution, such as the disinfectant's, pH, corrosivity, shelf life, and odor characteristics to name a few.

Manufacturers of on-site disinfectant generators currently have no way of standardizing and adjusting local water supplies being used in the on-site generators. It is well known that water being used in these machines is different based on the location of the water and the water treatment facility in the local region, therefore resulting in different products (disinfectants, sanitizers) will be different too.

Tap water, well water, purified water, distilled water, mineral water, and municipality water all have variations in pH, mineral content, free chlorine, total chlorine, dissolved organic solids, dissolved nonorganic solids, salinity, mineral contents, and other elements. Furthermore, other factors can affect water quality, such as materials and metal components found in pipes, age of pipes, and rust content, etc. In the process of electrolyzing salt water to create free chlorine, it is desired to control the type of chlorine species being created. Controlling the pH of the solution is also desired along with other characteristics.

PuriCore, Inc., located at 508 Lapp Road, Malvern, Pa. 19355, manufactures a saltwater electrolyte for use in its on-site electrochemical HOCl generator. Users purchasing the PuriCore, Inc. machine must also purchase saltwater electrolyte from PuriCore, Inc. to guarantee the end-product made is consistently the same. Though this approach may give end users a high degree of assurance that disinfectant solutions being produced will be consistently the same, increased costs of shipping salt water across the country have negative environmental effects and add enormous costs to the end-users of these machines.

Thus, a continuing need exists for a system and method for using local tap water and adjusting the water so that the end-product being produced will be standardized and mirror solutions used during microbiological testing.

### SUMMARY OF THE INVENTION

The present invention relates to a system for water adjustment for disinfectant generation and, more particularly, to a system for water adjustment for disinfectant generation using water from a local source. The system comprises water from a local source having a set of characteristics; a set of stable minerals and buffers produced in accordance with the set of characteristics of the water, when added to the water, control at least one chemical property of a desired disinfectant produced using the water; and an electrical device for delivering electricity to the water to produce the desired disinfectant.

In another aspect, the set of stable minerals and buffers are provided to an end user in one of a unit dose packet or a large container from which the end user measures a fixed amount.

In another aspect, an end user supplies a sample of the water to a laboratory for determination of the set of characteristics of the water.

In another aspect, a laboratory supplies an end user with a testing, element for determination of the set of characteristics of the water.

In another aspect, a laboratory contacts a local water purification system to obtain records related to the set of characteristics of the water.

In another aspect, the system further comprises a timer connected with the electrical device to allow an end user to adjust a time duration of the delivery of electricity to change the at least one chemical property of the desired disinfectant.

In another aspect, buffers in the set of stable minerals and buffers is at least one of an inorganic and an organic acid.

In another aspect, the electrical device comprises at least one of a voltage adjustment control and an amperage adjustment control, wherein an end user can adjust at least one of the voltage adjustment control and the amperage adjustment control to change the at least one chemical property of the desired disinfectant.

In another aspect, buffers in the set of stable minerals and buffers is selected from a group consisting of: sulfurous acid, hyposulfurous acid, pyrosulfuric acid, dithionous acid, thiosulfurous acid, peroxydisulfuric acid, hydrochloric acid, chlorous acid, hyponitrous acid, nitric acid, sulfuric acid, persulfuric acid, disulfurous acid, tetrathionic acid, hydrosulfuric acid, perchloric acid, hypochlorous acid, chloric acid, nitrous acid, and, pernitric acid.

In another aspect, buffers in the set of stable minerals and buffers is selected from a group consisting of: malonic acid, citric acid, tartartic acid, glutamic acid, phthalic acid, azelaic acid, barbituric acid, benzylic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid, acetylsalicylic acid, acetic acid, carbonous acid, hypocarbonous acid, oxalic acid, phosphoric acid, hypophosphous acid, hypophosphoric acid, hydrophosphoric acid, bromous acid, hypobromous acid, iodous acid, periodic acid, fluorous acid, carbonic acid, percarbonic acid, acetic acid, phosphorous acid, perphosphoric acid, pyrophosphoric acid, hydrobromic acid, bromic acid, hypoiodous acid, iodic acid, hydroiodic acid, fluoric acid, hypofluorous acid, hydrofluoric acid, chromous acid, perchromic acid, selenic acid, hydronitric acid, molybdic acid, silicofluoric acid, tellurous acid, xeric acid, formic acid, permanganic acid, antimonic acid, silicic acid, perfluoric acid, chromic acid, hypochromous acid, hydroselenic acid, selenous acid, boric acid, perxeric acid, telluric acid, tungstic acid, citiric acid, pyroantimonic acid, manganic acid, antimonous acid, titanic acid, arsenic acid, hydroarsenic acid, tetraboric acid, hypooxalous acid, cyanic acid, hydrocyanic acid, uranic acid, pertechnetic acid, dichromic acid, metastannic acid, ferricyanic acid, silicous acid, thiocyanic acid, and diuranic acid.

In another aspect, the set of characteristics of the water comprise at least one of water hardness level and total dissolved solids.

In another aspect, the present invention also comprises a method for generating a disinfectant using water from a local source.

### BRIEF DESCRIPTION OF THE DRAWINGS

The objects, features, and advantages of the present invention will be apparent from the following detailed descriptions of the various aspects of the invention in conjunction with reference to the following drawings, where:

FIG. 1 is a flow diagram illustrating a process of an end user supplying a sample of water from a local source to a laboratory according to the principles of the present invention;

FIG. 2 is a flow diagram illustrating a process of a laboratory supplying an end user with a testing element to test water from a local source according to the principles of the present invention;

FIG. 3 is a flow diagram illustrating a process of a laboratory contacting a local water purification system to obtain information related to water from a local source according to the principles of the present invention;

FIG. 4 is a table illustrating an example of how stable minerals and buffers can be added to water from a local source to obtain a pH of 6.5 according to the principles of the present invention;

FIG. 5 is a flow diagram illustrating a process of minerals and buffers being provided to an end user in an individual packet or large container to be added to the local water according to the principles of the present invention;

FIG. 6 is a flow diagram illustrating a process of an end user testing the water from a local source using a water kit according to the principles of the present invention;

FIG. 7 is a table illustrating that the stable minerals and buffers can be sold in packages uniquely labeled that when added will adjust the final disinfectant according to the principles of the present invention;

FIG. 8 is a table illustrating two ranges of a chemical property (pH in this example) established for the local source, resulting in two types of minerals and buffers being sold according to the principles of the present invention;

FIG. 9 is a table illustrating three ranges of a chemical property established for water from a local source, resulting in three types of minerals and buffers being sold according to the principles of the present invention;

FIG. 10 illustrates a device for adjusting the amount of time that a solution is electrolyzed according to the principles of the present invention;

FIG. 11 is a plot illustrating the relationship between chlorine species and pH of water;

FIG. 12 is a table of inorganic acids and their associated salts;

FIG. 13 is a table of common organic acids and their associated salts;

FIG. 14 is a table of common organic acids and their associated salts;

FIG. 15 is a table of common organic acids and their associated salts; and

FIG. 16 is table of common organic acids and their associated salts.

### DETAILED DESCRIPTION

The present invention relates to system for water adjustment for disinfectant generation and, more particularly, to a system for water adjustment for disinfectant generation using water from a local source. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide amore thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function or “step for” performing a specific function is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Specific Details

Disinfectant can be generated through electrolysis by combining water, minerals, buffers, and electricity. When salt (e.g., sodium chloride (NaCl)) is electrolyzed, the chlorine (Cl) off of the NaCl molecule binds to hydrogen and oxygen to form HOCl and other chlorine species. HOCl, or free chlorine as it is referred to, is the active form of chlorine that is used as a disinfectant. Once a machine has generated HOCl disinfectant, this disinfectant has unique chemical properties such as pH, oxidation reduction potential (ORP), and amount of free chlorine (measured in parts per million (ppm)).

The formula below describes how HOCl is made through electrolysis.

Water+Minerals+Buffers+Electricity≈Disinfectant HOCl+other chlorine species

In the above equation, the minerals and buffers can be standardized by supplying end users stable, packaged minerals and buffers. The electricity can be stabilized by providing end users with electrical devices that repeatedly produce the same output of energy delivered across electrodes. The variable that was not controllable before was the local water. With the present invention, the local water can be standardized by supplying end users with an additive (or additives) that end users can titrate into their local water, such that the desired chlorine species can be controlled.

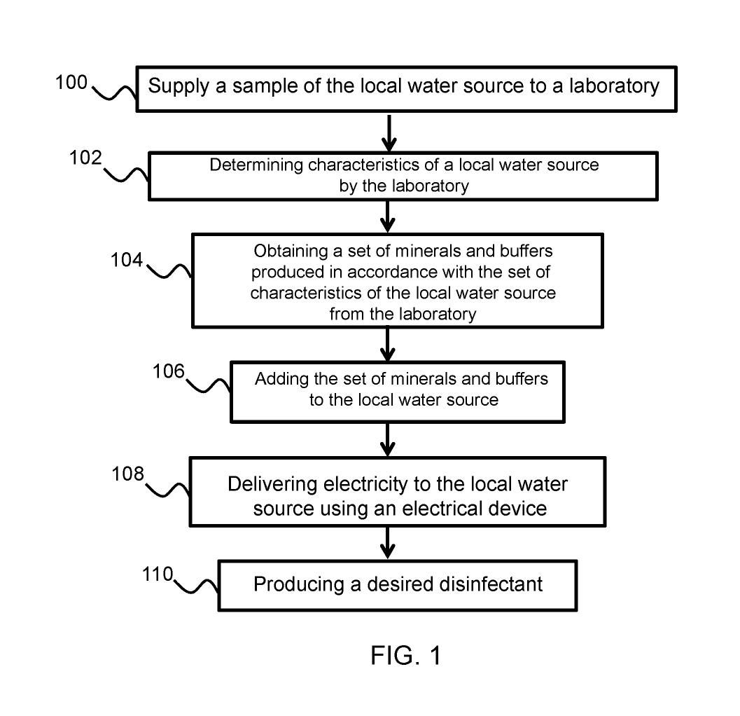

There are multiple ways in which an end user can adjust their local water for creation of a disinfectant. In one aspect of the invention, illustrated in FIG. 1, end users would first need to supply a sample of the water they wish to use to a laboratory (element 100). A shipping container with a specimen jar would be provided to the end user. A laboratory would then run a standardized test on the water sample to determine its characteristics (element 102). Next, the laboratory would produce a set of minerals and buffers and supply them to the end user (element 104) to add to their local water (element 106). For example, in the case of pH, the buffer would be in the form of an acid or a base. A custom mineral and buffer packet can be produced for the individual that adjusts the water correctly to meet the disinfectants requirements. Electricity is delivered to the local water source using an electrical device (element 108), and the desired disinfectant is produced (element 110).

Once the manufacturer determines the water adjustments that are necessary, the manufacturer can catalog the findings in a database for future use for end users in the same region. For instance, zip codes can be used to associate different addressed with water samples received, thus, eliminating the need to perform the tests again when end users inform the manufacturer that they are going to be using water from a specific zip code. Rather, the end user can provide his or her zip coded, and the proper adjusted electrolyte can be provided.

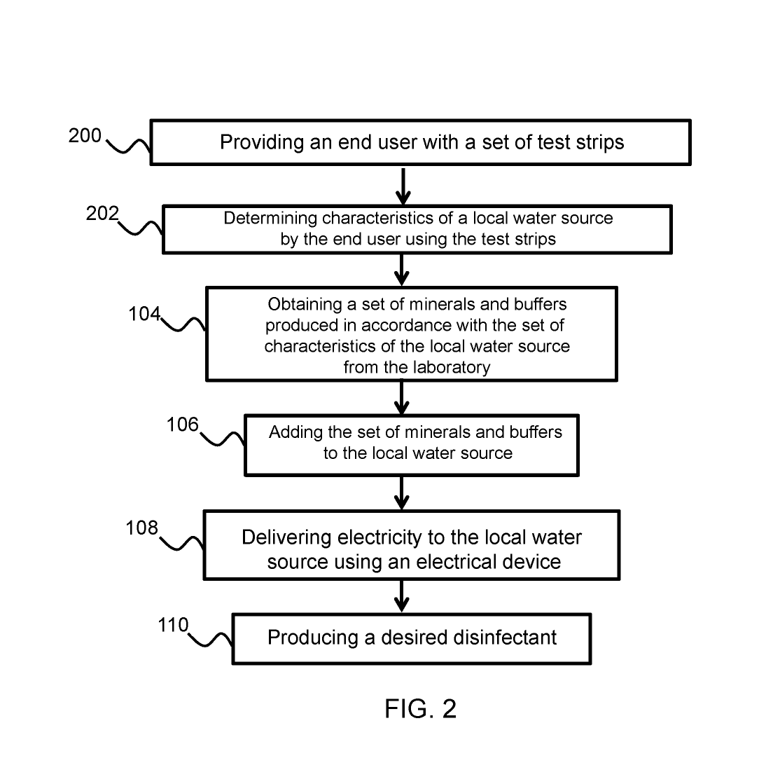

In another aspect, depicted in FIG. 2, a laboratory can supply end users with test strips (element 200) that allow the end users to test various attributes of their water in their homes or offices (element 202). These findings can then be reported back to the laboratory, and the laboratory can manufacture an additive (e.g., buffer) specifically for the end-user's local water (element 104). For the purposes of this application, a buffer can be can be acid(s) or other chemicals that will alter the local water source to produce an effective disinfectant.

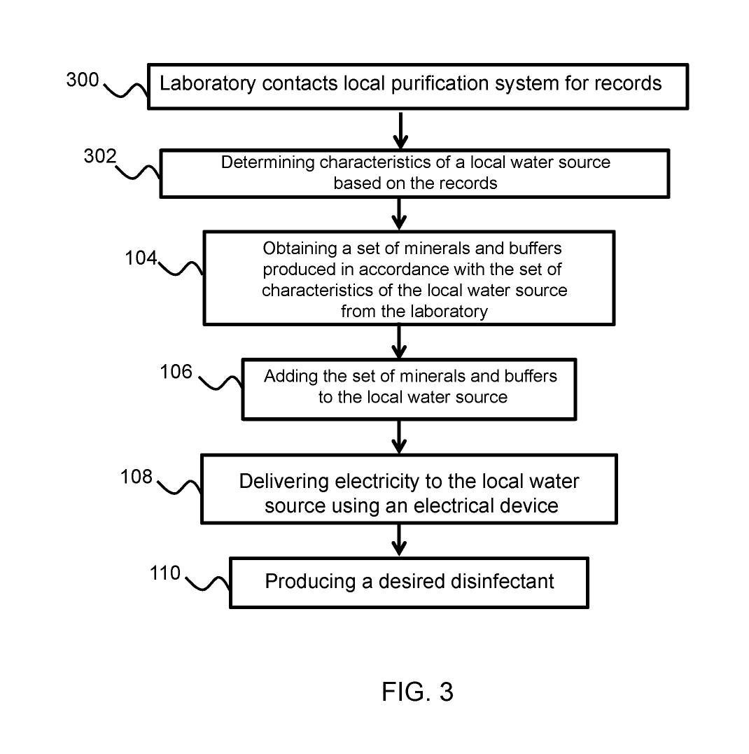

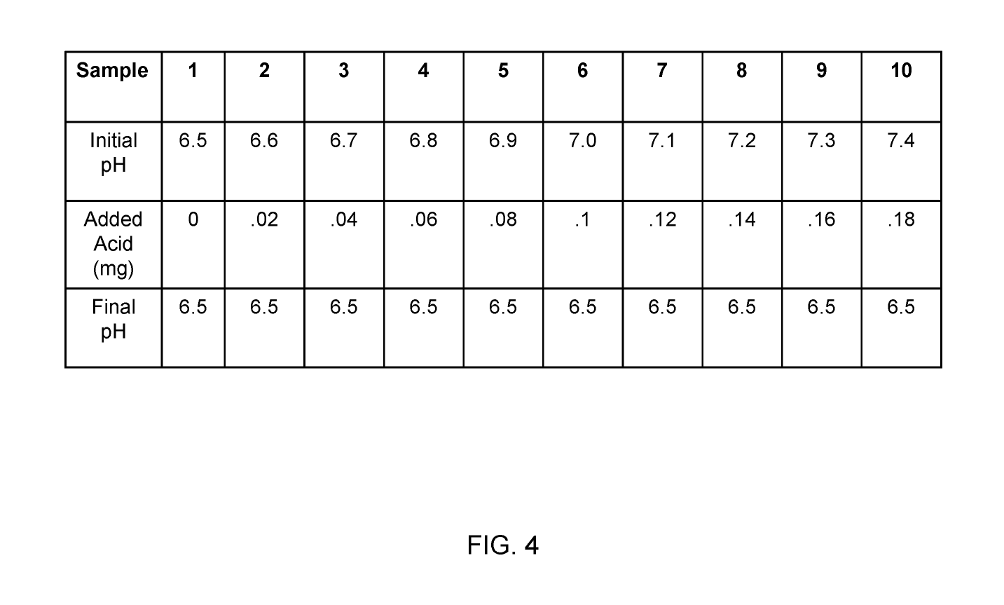

In another aspect, as shown in FIG. 3, a laboratory can contact local water purification systems and get copies of their annual water reports/records (element 300), catalog the information by end, user's zip code or region, and adjust buffers and salt electrolytes as needed based on the published community data (element 104). There may be hundreds to thousands (or more) of different sources of water available for use in the disinfectant generator. Based on the records, the manufacturer may determine that one water characteristic (or more) needs to be adjusted (element 302) and, therefore, be able to categorize thousands of water sample data sets into smaller subsets. FIG. 4 illustrates a non-limiting example of how a pH of 6.5 can be, obtained, This example represents an acid that will decrease the pH of water by 0.1 for each 0.01 mg of acid being added. The final pH in each example for the ten samples is buffered to pH 6.5. Based on the initial pH, the amount of acid can be calculated to reduce the pH to 6.5.

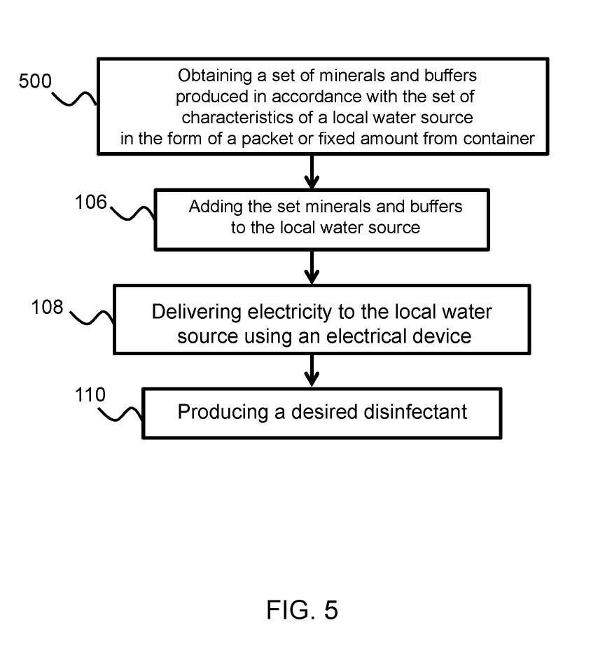

In yet another aspect, depicted in FIG. 5, the salt and pH buffer can be provided to the end user in a unit dose packet, or a large container from which the end user measures a fixed amount of the combined salt and buffer (element 500), that when combined with a fixed amount of tap or local water (element 106) to be used in a electrolysis generating machine (element 108) will produce the desired disinfectant in a repeatable manner (element 110).

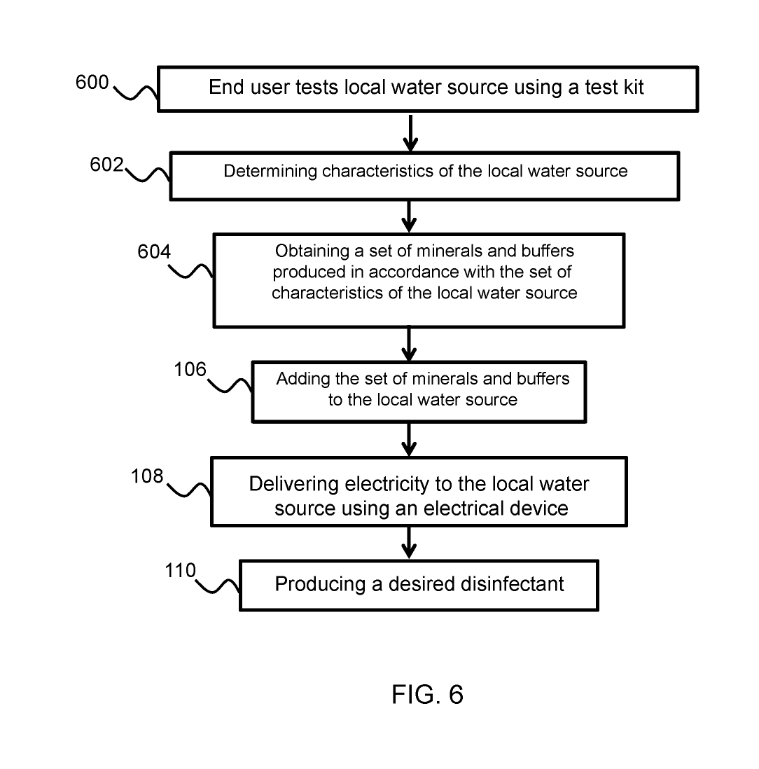

In another aspect, shown in FIG. 6, the end user can test water from a local source using numerous water kits (element 600), then compare the reading to a buffer adjustment chart provided to the end user (element 602). Then, based on the needed adjustment(s), the required butlers (element 604) would be dispensed into the water by the end user (element 106), making the adjustments without the need for consulting with a laboratory.

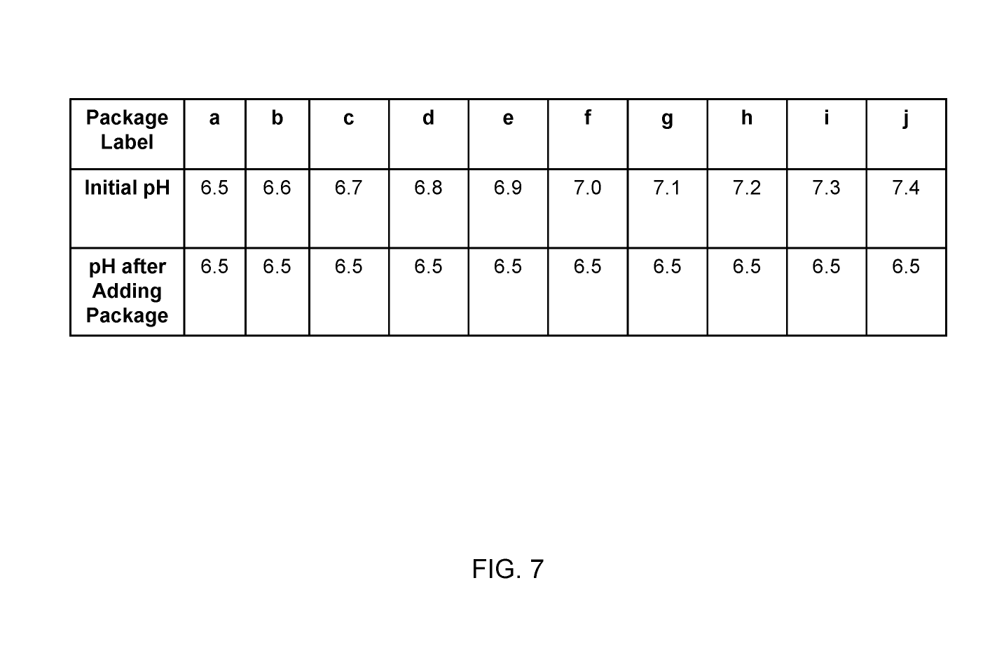

In the above example, the manufacturer could then produce buffering acid solutions and label them appropriately (1, 2, 3, 4, 5, 6, 7, 8, 9) or (a, b, c, d, e, f, g, h, i) and provide end users with the buffering agents that will create the same standardized pH of 6.5. The buffer can be sold separately and added, or the buffer can be included inside a salt packet. Each packet of salt would contain the amount of acid needed to create a pH of 6.5 and create the proper amount of chlorine in parts per million (ppm). Additives can be sold in any increment, such as one for each tenth of a pH increment, as depicted in FIG. 7.

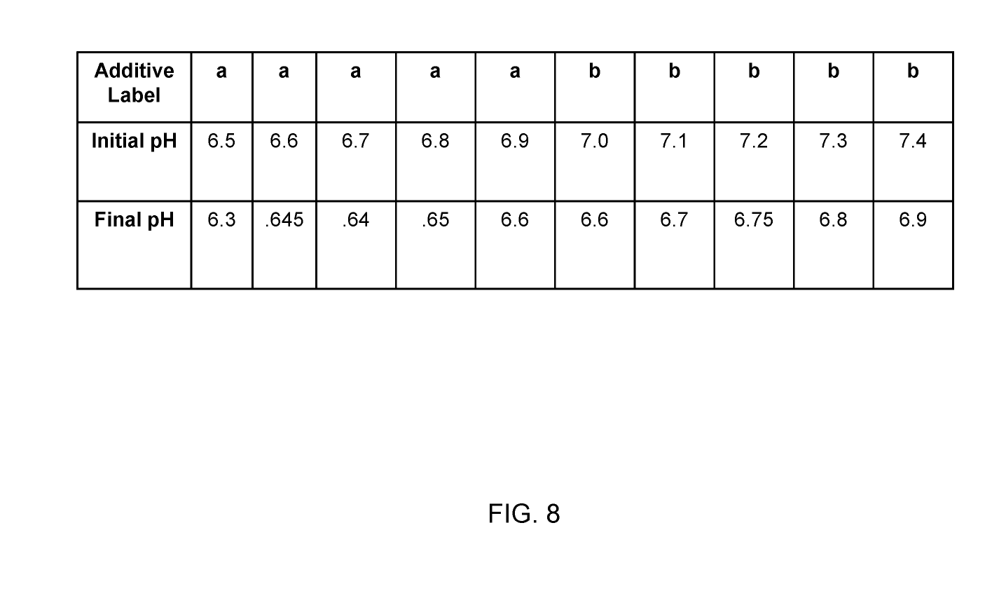

In the non-limiting example shown in FIG. 8, a range is determined, effectively allowing only two additives (labeled “a” and “b”) to be sold. For instance additive “a” covers initial pH levels ranging from 6.5 to 6.9, while additive “b” covers initial pH levels ranging from 7.0 to 7.4. For additive “a”, microbiology of the final disinfectant; produced by the machines would be tested using water with pH ranging between 6.3 and 6.6. For “b”, microbiology of the final disinfectant produced by the machines would be tested using water with pH ranging from 6.6-6.9.

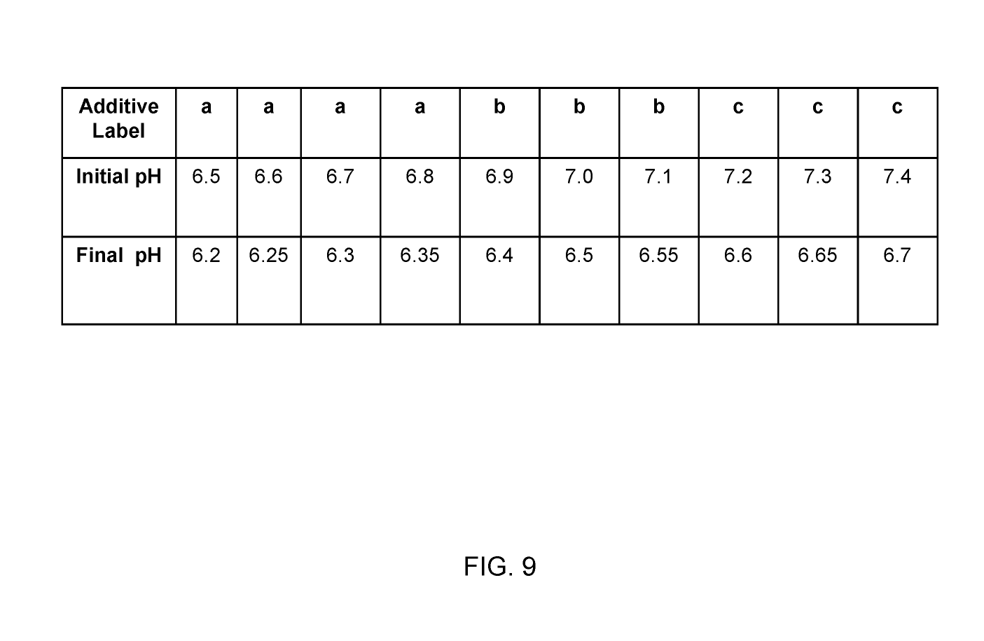

In FIG. 9, three ranges are established for pH (labeled “a”, “b”, and “c”). The ranges can change based on the pH level decimal points (e.g., tenths 0.1), hundredths (0.01), and thousandths (0.001), and the number of unique divisions can increase or decrease depending on the level of adjusting the manufacturer wishes to dial in. If there is more than on variable that needs adjusting, individualized additives can be packaged and provided to change water hardness, dissolved solids, etc.

In yet another aspect, different acids and/or corresponding salts, alone or in combination, in different percentages can be used to alter or enhance a water solution's characteristics. As can be appreciated by one skilled in the art, any number of suitable acids and salts can be used in conjunction with the present invention. Further, not only can acids act as additives, but they can also enhance the disinfection characteristics of the final generated disinfecting solutions. For example, a salt brine acidified with acetic acid (vinegar enhances the cleaning effects of a disinfectant solution produced after electrolysis.

Additives can be packaged and delivered to sites generating disinfectants in various forms, such as, but not limited to, eye dropper bottles, dropper bottles, syringes, vials, unit dose dispensing containers, tablets, pills, capsules, or in large bottles that require a measuring spoon or graduated cylinder to dispense.

In another aspect, water characteristics determined are not limited to pH, but can also include any water characteristic that can be adjusted according to the method described herein. For instance, water hardness can be tested and then adjusted using chemicals, such as borate or lime, in accordance with the principles of the present invention. Further, any additional water characteristics, such as total dissolved solids, may be tested and the water adjusted with the appropriate chemical addition and electrolyzed according to the method described herein.

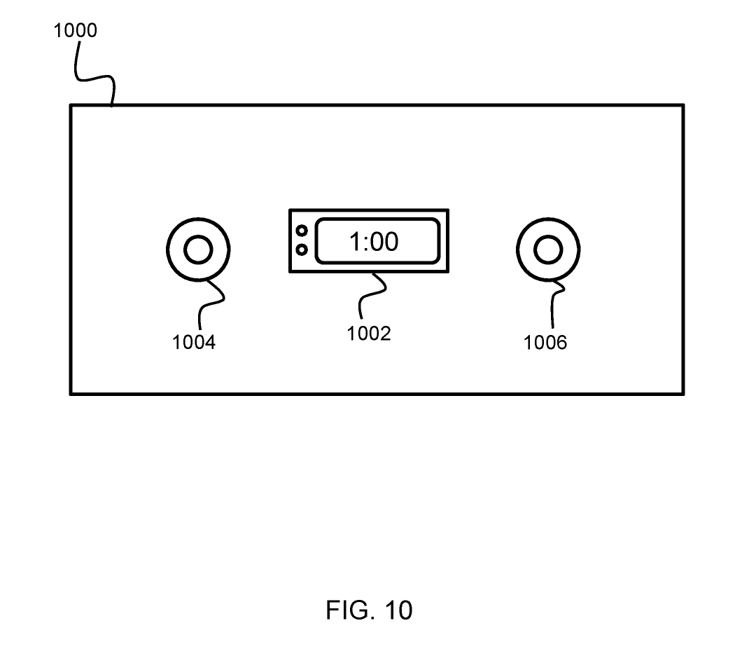

As illustrated in FIG. 10, another aspect allows end users to adjust the amount of time that solutions are electrolyzed using the electrical device 1000 by use of a timer 1002. Additionally, the electrical device 1000 comprises a voltage adjustment control 1004 and an amperage adjustment control 1006 to adjust the voltage and amperage, respectively, of the electricity moving through the electrodes of the electrical device 1000. By adjusting the time and/or voltage and/or amperage, the end user can change the characteristics of the disinfectant being produced.

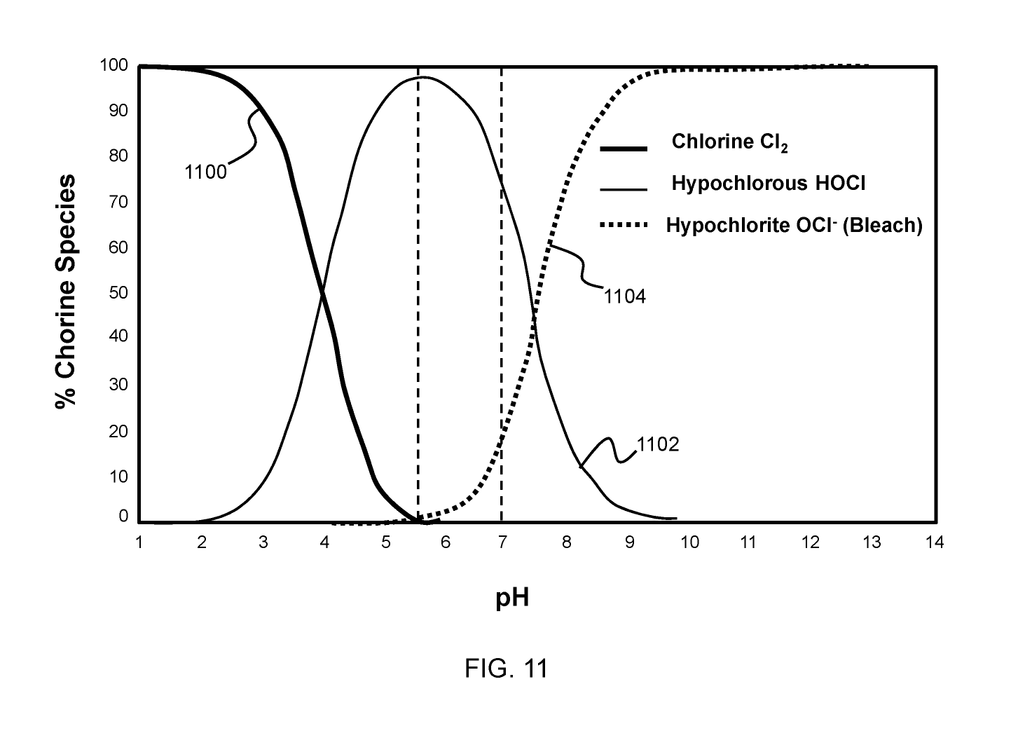

Yet another aspect of the present invention comprises altering the amount of NaCl in the electrolyte package, the end user can change the percentage of free chlorine being produced. The production of free chlorine from the electrolysis of salt brine is directly related to the amount of NaCl in solution. The additional of salt can be used to change the pH of the water, which can then be used to alter the chlorine species produces. For example, FIG. 11 is a graph plotting percent chlorine species (y-axis) versus pH (x-axis). The bold solid line curve 1100 represents chlorine Cl₂, the unbolded solid line curve 1102 represents hypochlorous HOCl, and the bold dashed line curve 1104 represents hypochlorite OCl⁻. Using this graph, a user can determine what type of chlorine species, would be created given a specific water pH. For example, a pH of 5.6 produces the highest levels of hypochlorous HOCl. If the pH of the water is 10, the solution would have almost no hypochlorous HOCl and high levels of hypochlorite (i.e., bleach). A desired species of chlorine in any disinfecting solution is hypochlorous. Hypochorite is very caustic as compared to hypochlorous.

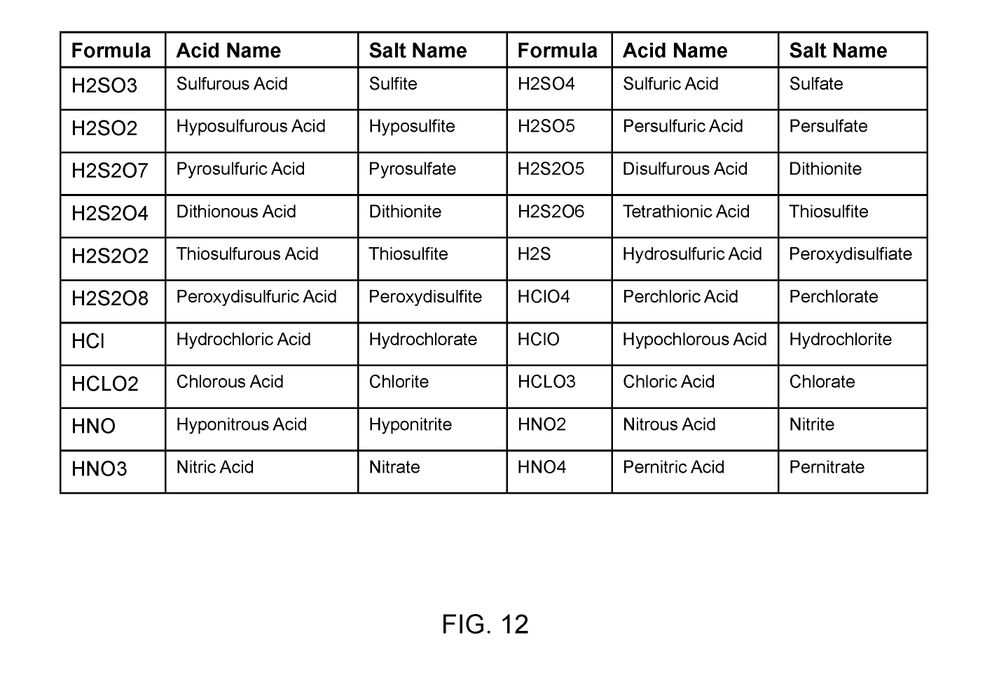

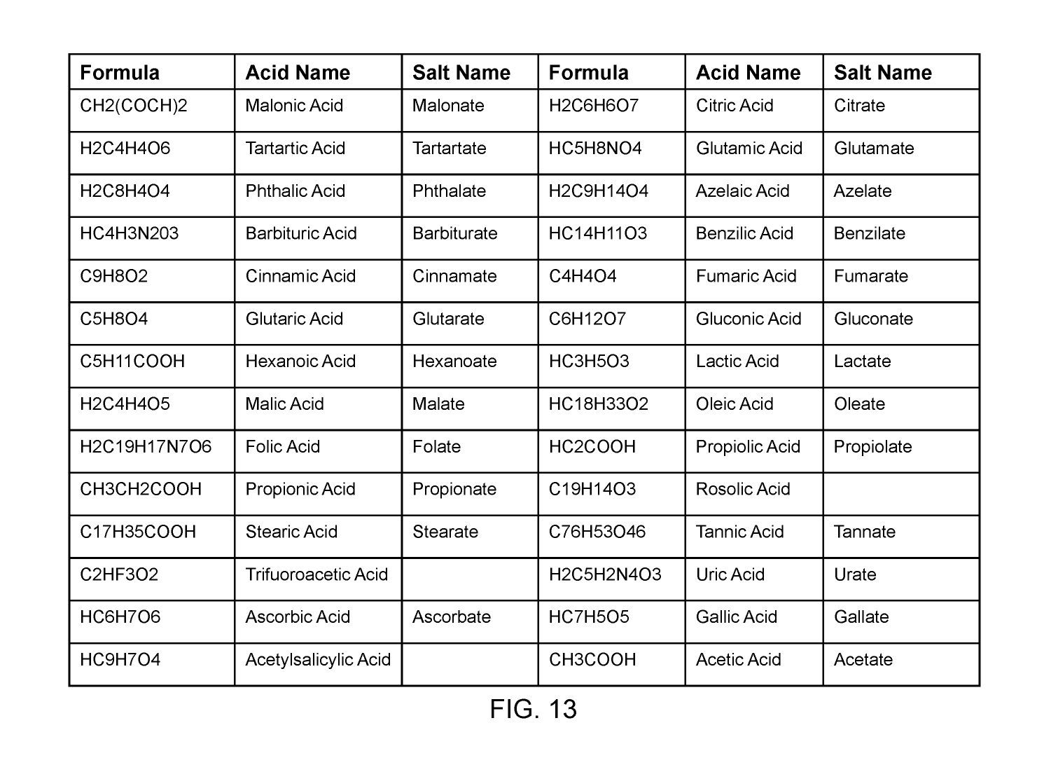

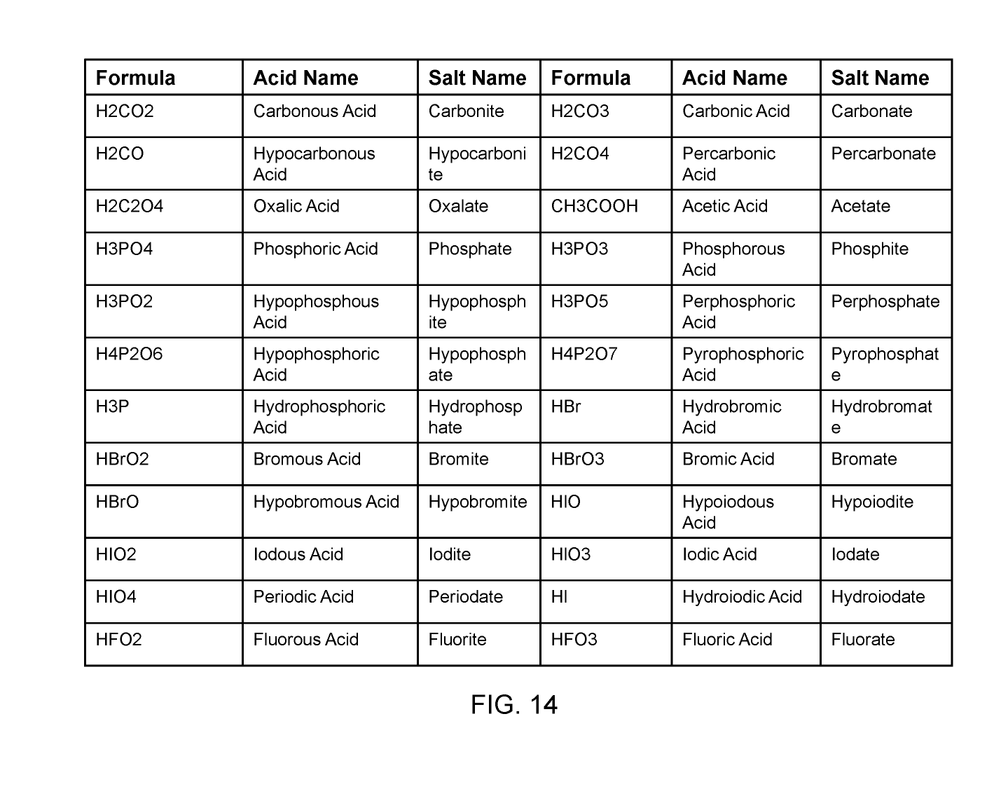

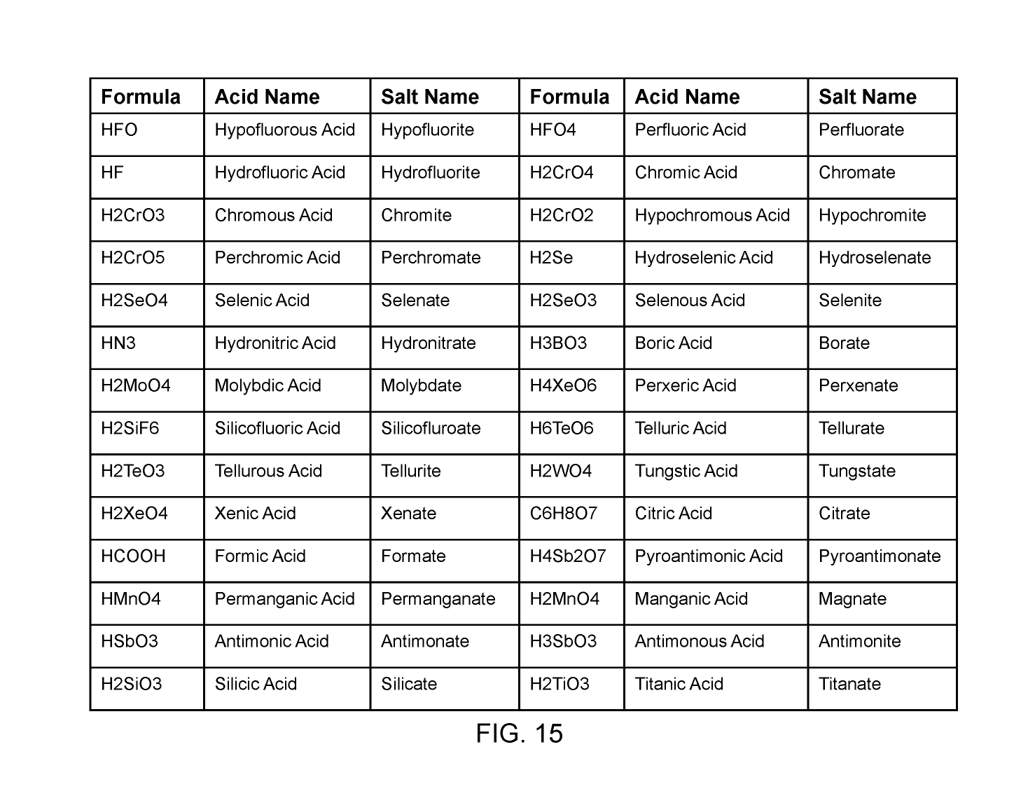

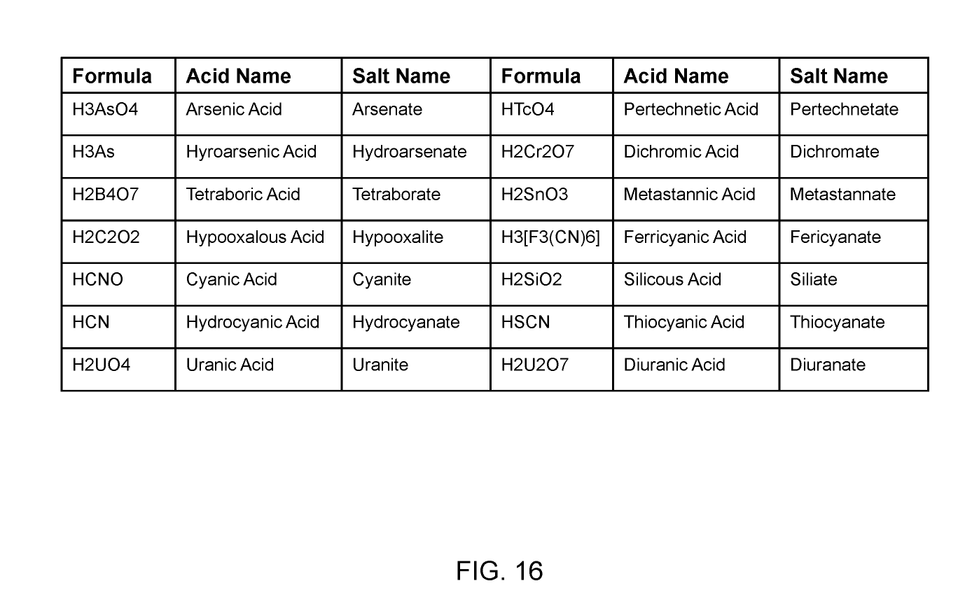

FIG. 12 is a table listing inorganic acids and their associated salts. FIGS. 13-16 are tables listing common organic acids and their associated salts. Any single or combination of acids, non-limiting examples of which are listed in FIGS. 12-16, may be used in the system described herein.

What is claimed is:

1. A system for generating a disinfectant using a local water source, the system comprising:
water from a local source having a set of characteristics;
a set of stable minerals and buffers produced in accordance with the set of characteristics of the water which, when added to the water, control at least one chemical property of a desired disinfectant produced using the water; and
an electrical device for delivering electricity to the water to produce the desired disinfectant.

2. The system as set forth in claim 1, wherein the set of stable minerals and buffers are provided to an end user in one of a unit dose packet or a large container from which the end user measures a fixed amount.

3. The system as set forth in claim 2, wherein an end user supplies a sample of the water to a laboratory for determination of the set of characteristics of the water.

4. The system as set forth in claim 2, wherein a laboratory supplies an end user with a testing element for determination of the set of characteristics of the water.

2. The system as set forth in claim 2, wherein a laboratory contacts a local water purification system to obtain records related to the set of characteristics of the water.

6. The system as set forth in claim 1, further comprising a timer connected with the electrical device to allow an end user to adjust a time duration of the delivery of electricity to change the at least one chemical property of the desired disinfectant.

7. The system as set forth in claim 1, wherein the electrical device comprises at least one of a voltage adjustment control and an amperage adjustment control, wherein an end user can adjust at least one of the voltage adjustment control and the amperage adjustment control to change the at least one chemical property of the desired disinfectant.

8. The system as set forth in claim 1, wherein buffers in the set of stable minerals and buffers is at least one of an inorganic and an organic acid.

9. The system as set forth in claim 1, wherein buffers in the set of stable minerals and buffers is selected from a group consisting of sulfurous acid, hyposulfurous acid, pyrosulfuric acid, dithionous acid, thiosulfurous acid, peroxydisulfuric acid, hydrochloric acid, chlorous acid, hyponitrous acid, nitric acid, sulfuric acid, persulfuric acid, disulfurous acid, tetrathionic acid, hydrosulfuric acid, perchloric acid, hypochlorous acid, chloric acid, nitrous acid, and pernitric acid.

10. The system as set forth in claim 1, wherein buffers in the set of stable minerals and buffers is selected from a group consisting of: malonic acid, citric acid, tartartic acid, glutamic acid, phthalic acid, azelaic acid, barbituric acid, benzylic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid, acetylsalicylic acid, acetic acid, carbonous acid, hypocarbonous acid, oxalic acid, phosphoric acid, hypophosphous acid, hypophosphoric acid, hydrophosphoric acid, bromous acid, hypobromous acid, iodous acid, periodic acid, fluorous acid, carbonic acid, percarbonic acid, acetic acid, phosphorous acid, perphosphoric acid, pyrophosphoric acid, hydrobromic acid, bromic acid, hypoiodous acid, iodic acid, hydroiodic acid, fluoric acid, hypofluorous acid, hydrofluoric acid, chromous acid, perchromic acid, selenic acid, hydronitric acid, molybdic acid, silicofluoric acid, tellurous acid, xeric acid, formic acid, permanganic acid, antimonic acid, silicic acid, perfluoric acid, chromic acid, hypochromous acid, hydroselenic acid, selenous acid, boric acid, perxeric acid, telluric acid, tungstic acid, citiric acid, pyroantimonic acid, manganic acid, antimonous acid, titanic acid, arsenic acid, hydroarsenic acid, tetraboric acid, hypooxalous acid, cyanic acid, hydrocyanic acid, uranic acid, pertechnetic acid, dichromic acid, metastannic acid, ferricyanic acid, silicous acid, thiocyanic acid, and diuranic acid.

11. The system as set forth in claim 1, wherein the set of characteristics of the water comprise at least one of water hardness level and total dissolved solids.

12. A method for generating a disinfectant using a local water source, comprising acts of:
determining a set of characteristics of water from a local source;
obtaining a set of stable minerals and buffers produced in accordance with the set of characteristics of the water;
adding the set of stable minerals and buffers to the water to control at least one chemical property of a desired disinfectant produced using the water;
delivering electricity to the water using an electrical device; and
producing the desired disinfectant.

13. The method as set forth in claim 12, further comprising an act of:
providing an end user with the set of stable minerals and buffers in one of a unit dose packet or a large container from which the end user measures a fixed amount.

14. The method as set forth in claim 13, further comprising an act of:
supplying a sample of the water to a laboratory for determination of the set of characteristics of the water.

15. The method as set forth in claim 13, further comprising an act of:
supplying an end user with a testing element for determination of the set of characteristics of the water.

16. The method as set forth in claim 13, further comprising an act of:
contacting a local water purification system to obtain records related to the set of characteristics of the water.

17. The method as set forth in claim 12, further comprising an act of:
adjusting a time duration of the delivery of electricity to change the at least one chemical property of the disinfectant.

18. The method as set forth in claim 12, further comprising an act of:
adjusting at least one of a voltage adjustment control and an amperage adjustment control of the electrical device to change the at least one chemical property of the disinfectant.

19. The method as set forth in claim 12, wherein buffers in the set of stable minerals and buffers is selected from a group consisting of: sulfurous acid, hyposulfurous acid, pyrosulfuric acid, dithionous acid, thiosulfurous acid, peroxydisulfuric acid, hydrochloric acid, chlorous acid, hyponitrous acid, nitric acid, sulfuric acid, persulfuric acid, disulfurous acid, tetrathionic acid, hydrosulfuric acid, perchloric acid, hypochlorous acid, chloric acid, nitrous acid, and pernitric acid.

20. The method as set forth in claim 12, wherein buffers in the set of stable minerals and buffers is selected from a group consisting of malonic acid, citric acid, tartartic acid, glutamic acid, phthalic acid, azelaic acid, barbituric acid, benzylic acid, cinnamic acid, fumaric acid, glutaric acid, gluconic acid, hexanoic acid, tactic acid, malic acid, oleic acid, folic acid, propiolic acid, propionic acid, rosolic acid, stearic acid, tannic acid, trifluoroacetic acid, uric acid, ascorbic acid, gallic acid, acetylsalicylic acid, acetic acid, carbonous acid, hypocarbonous acid, oxalic acid, phosphoric acid, hypophosphous acid, hypophosphoric acid, hydrophosphoric acid, bromous acid, hypobromous acid, iodous acid, periodic acid, fluorous acid, carbonic acid, percarbonic acid, acetic acid, phosphorous acid, perphosphoric acid, pyrophosphoric acid, hydrobromic acid, bromic acid, hypoiodous acid, iodic acid, hydroiodic acid, fluoric acid, hypofluorous acid, hydrofluoric acid, chromous acid, perchromic acid, selenic acid, hydronitric acid, molybdic acid, silicofluoric acid, tellurous acid, xenic acid, formic acid, permanganic acid, antimonic acid, silicic acid, perfluoric acid, chromic acid, hypochromous acid, hydroselenic acid, sclerous acid, boric acid, perxeric acid, telluric acid, tungstic acid, citiric acid, pyroantimonic acid, manganic acid, antimonous acid, titanic acid, arsenic acid, hydroarsenic acid, tetraboric acid, hypooxalous acid, cyanic acid, hydrocyanic acid, uranic acid, pertechnetic acid, dichromic acid, metastannic acid, ferricyanic acid, silicous acid, thiocyanic acid, and diuranic acid.
